(19) United States
(12) Patent Application Publication
(10) Pub. No.: US 2017/0125007 A1
(43) Pub. Date: May 4, 2017

(54) ACOUSTIC CONVERSION DEVICE FOR ACTIVE NOISE CONTROL

(71) Applicants: PIONEER CORPORATION, Tokyo (JP); Tohoku Pioneer Corporation, Yamagat (JP)

(72) Inventor: Junichi IIDA, Yamagata (JP)

(21) Appl. No.: 15/128,289

(22) PCT Filed: Mar. 24, 2014
(86) PCT No.: PCT/JP2014/058113

§ 371 Date: Sep. 22, 2016

(51) Int. Cl. G10K 11/178; H04R 1/34

(52) U.S. Cl. CPC G10K 11/1788; H04R 1/345; H04R 2499/13

(57) ABSTRACT

An acoustic conversion device for an active noise control including a protection member is provided. Since the protection member hides an entire opening, all of water and foreign matters which pass through the opening arrive at an upper surface of the protection member. Further, since the protection member hides the entire speaker unit, it is possible to protect a vibration plate of the speaker unit from water and foreign matters which drop from the protection member. Therefore, water and foreign matters are prevented from adhering to the vibration plate, it is possible to prevent lowest resonance frequency from being varied, emitted sound can be less prone to be deviated from opposite phase of noise, and it is possible to effectively suppress or remove noise.

### TECHNICAL FIELD

The present invention relates to an acoustic conversion device for an active noise control.

### BACKGROUND ART

There is conventionally proposed a noise canceling device (acoustic conversion device for active noise control) for suppressing or removing noise around a vehicle (e.g., refer to Patent Literature 1). According to the conventional noise canceling device described in Patent Literature 1, sound having opposite phase to noise is emitted into a room space of the vehicle, thereby suppressing or removing the noise.

### CITATION LIST

### Patent Literature

Patent Literature 1: JP 2002-351488 A

### SUMMARY OF INVENTION

### Technical Problem

According to the conventional noise canceling device described in Patent Literature 1, it is preferable that the noise canceling device is placed in the vicinity of a passenger so that the emitted sound easily arrives at the passenger, but it is also required to prevent the room space from narrowing extremely and to prevent the noise canceling device from interfering with other members. Hence, it seems possible to employ such a configuration that the noise canceling device is placed under a floor of the vehicle, and sound is emitted to the room space through an opening formed in the floor. According to this configuration, however, water and foreign matters enter a vibration plate of a speaker unit through the opening, and there is a possibility that lowest resonance frequency of the speaker unit is varied. If the lowest resonance frequency is varied, phase of sound emitted from the vibration plate of the speaker unit is varied, the sound is deviated from the opposite phase of the noise to be suppressed or removed, and a suppressing effect or a removing effect of noise is lowered.

It is an object of the present invention to provide an acoustic conversion device for an active noise control capable of preventing water or foreign matters from entering the vibration plate of the speaker unit, thereby preventing the lowest resonance frequency of the speaker unit from being varied, capable of preventing unintentional deviation of phase of sound emitted from the speaker unit, and capable of effectively suppressing or removing noise.

### Solution to Problem

In order to solve the problem and achieve the object, an acoustic conversion device for an active noise control of the present invention includes: a speaker unit which is provided below an opening formed in a floor of a vehicle and which emits sound to a room space of the vehicle through the opening; an enclosure in which the speaker unit is accommodated; and a protection member provided between the opening and the speaker unit, wherein the speaker unit includes a vibration plate for emitting sound, an edge for supporting the vibration plate, and a frame for supporting the edge, and an outer peripheral edge of the protection member is located above the vibration plate, and is located on more outer side than an outer peripheral edge of the vibration plate.

### BRIEF DESCRIPTION OF DRAWINGS

FIGS. 1A to 1C are schematic diagrams illustrating an acoustic conversion device for an active noise control according to Example 1 of an embodiment of the present invention.

FIG. 2 is a side view illustrating a state where the acoustic conversion device for the active noise control is provided in a vehicle.

FIG. 3 is a schematic diagram illustrating an acoustic conversion device for an active noise control according to Example 2.

FIG. 4 is a schematic diagram illustrating an acoustic conversion device for an active noise control according to Example 3.

FIG. 5 is a schematic diagram illustrating an acoustic conversion device for an active noise control according to Example 4.

FIG. 6 is a schematic diagram illustrating an acoustic conversion device for an active noise control according to Example 5.

FIG. 7 is a side view illustrating a state where an acoustic conversion device for an active noise control according to a modification is provided in a vehicle.

FIG. 8 is a side view illustrating a state where an acoustic conversion device for an active noise control according to another modification is provided in a vehicle.

### DESCRIPTION OF EMBODIMENT

An embodiment of the present invention will be described below. An acoustic conversion device for an active noise control according to an embodiment of the present invention includes: speaker unit which is provided below an opening formed in a floor of a vehicle and which emits sound to a room space of the vehicle through the opening; an enclosure in which the speaker unit is accommodated; and a protection member provided between the opening and the speaker unit, wherein the speaker unit includes a vibration plate for emitting sound, an edge for supporting the vibration plate, and a frame for supporting the edge, and an outer peripheral edge of the protection member is located above the vibration plate, and is located on more outer side than an outer peripheral edge of the vibration plate.

The outer peripheral edge of the protection member is located above the vibration plate and is located on more outer side than an outer peripheral edge of the vibration plate. Thereby, it is possible to protect the vibration plate from water and foreign matters which pass through the opening. That is, it is possible to prevent water and foreign matters from adhering to a vibrating portion of the speaker unit, to prevent lowest resonance frequency from being varied, and to effectively suppress or remove noise. It is only necessary that the protection member has the above-described area in a surface along the opening, the protection member may be of a plate-shape or a block-shape, and size of the protection member in the vertical direction is not limited.

Furthermore, it is preferable that the outer peripheral edge of the protection member is located below the opening, and is located on more outer side than an outer peripheral edge of the opening. Thereby, an upper surface of the protection member can easily receive water and foreign matters which pass through the opening, and it is possible to avoid such a case that water and foreign matters which diagonally drop and pass through the opening are not shut out by the protection member, and the water and foreign matters arrive at the vibration plate.

It is preferable that an upper surface of the protection member includes a protection inclined member, and an outer peripheral edge of the protection inclined surface is located below its central portion. Thereby, water and foreign matters which pass through the opening move downward toward the outer peripheral edge in the protection inclined surface, and do not easily drop inward in the outer peripheral edge. Therefore, it is possible to reliably protect the vibration plate from water and foreign matters.

It is preferable that the speaker unit is provided on an upper surface of the enclosure, and the outer peripheral edge of the protection member is located on more outer side than an outer peripheral edge of an upper surface of the enclosure. According to this, the protection member can hide the entire upper surface of the enclosure, water and foreign matters are prevented from arriving at the upper surface, and it is possible to prevent water and foreign matters from transmitting along the upper surface and from entering the speaker unit. Therefore, it is possible to more reliably protect the vibration plate from water and foreign matters.

It is preferable that the speaker unit is provided in a hole formed in an upper surface of the enclosure, and an outer peripheral edge of the upper surface of the enclosure includes a discharge inclined surface located lower than an outer peripheral edge of the hole. According to this, water and foreign matters which arrive at the upper surface of the enclosure can be discharged downward by the discharge inclined surface, and it is possible to prevent water and foreign matters from staying around the speaker unit. Therefore, it is possible to more reliably protect the vibration plate from water and foreign matters.

It is preferable that a sound-introducing path through which sound emitted from the speaker unit can pass is formed between a lower surface of the floor and an upper surface of the protection member. According to this, sound emitted from the speaker unit can easily reach a passenger.

The acoustic conversion device for an active noise control further includes a sound-introducing member which can guide sound emitted from the speaker unit to the sound-introducing path, and it is preferable that the sound-introducing member includes a cylindrical member which surrounds the speaker unit and the protection member from outside. According to this, sound emitted diagonally upward from the speaker unit is not only diffracted by the outer peripheral edge of the protection member but also are reflected inward by the cylindrical member and moves toward the sound-introducing path. Therefore, the emitted sound can more easily reach the passenger.

It is preferable that a lower surface of the protection member is provided with a diffuser which is downwardly convex. According to this, sound emitted upward from the speaker unit is guided outward by the diffuser, the sound is prone to be diffracted at the outer peripheral edge of the protection member, and the emitted sound can easily reach the passenger.

It is preferable that the vibration plate is formed into a flat surface shape. According to this, even if water and foreign matters enter the speaker unit, the water and foreign matters do not easily stay on the vibration plate.

### EXAMPLES

An embodiment of the present invention will specifically be described below. In Examples 2 to 5, the same reference signs are allocated to the same constituent members as those of Example 1 and to constituent members having the same functions as those of Example 1, and explanation thereof will be omitted.

### Example 1

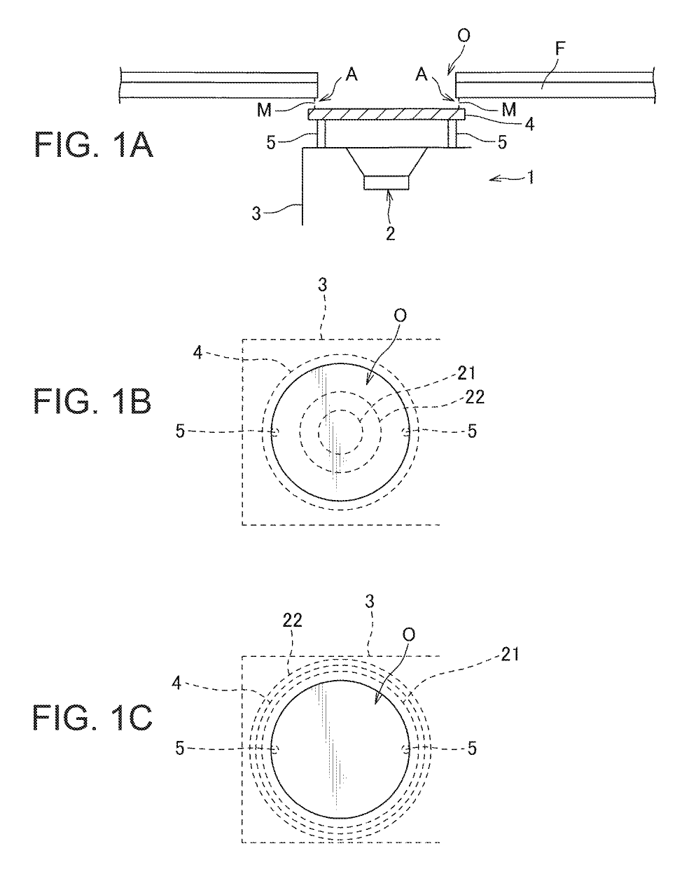

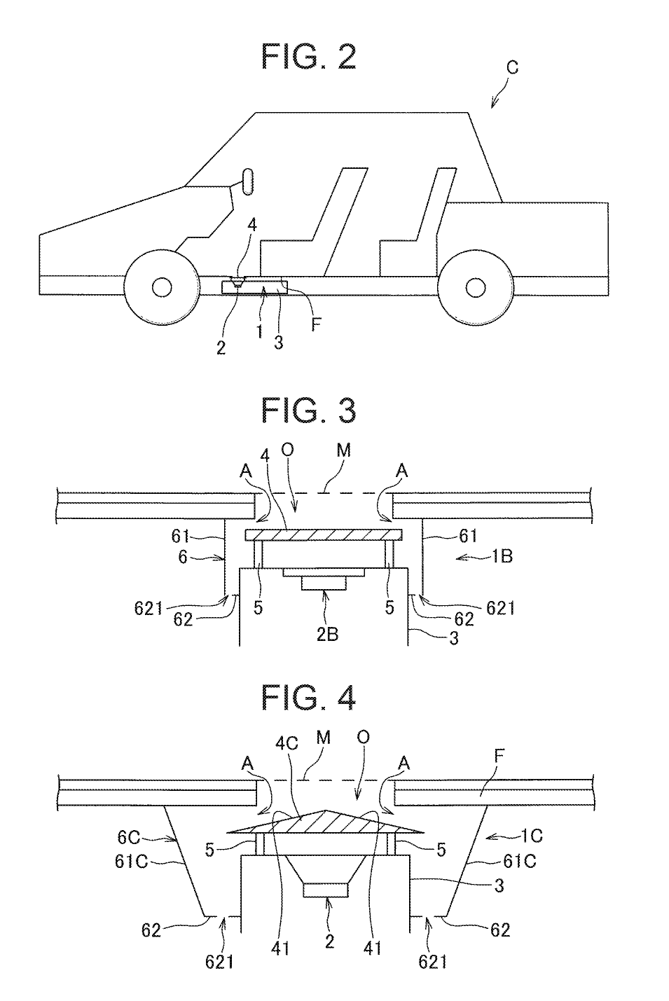

FIGS. 1A to 1C are schematic diagrams illustrating an acoustic conversion device 1 for an active noise control according to Example 1 of the present invention. FIG. 2 is a side view illustrating a state where the acoustic conversion device 1 for the active noise control is provided in a vehicle C.

The acoustic conversion device 1 for the active noise control includes a speaker unit 2 provided below an opening O formed in a floor F of the vehicle C, an enclosure 3 for accommodating the speaker unit 2 therein, and a protection member 4 provided between the opening O and the speaker unit 2. The acoustic conversion device 1 for the active noise control is configured to suppress or remove noise (e.g., engine sound) in a room space of the vehicle C. The opening O is formed into a substantially circular shape at foot of a passenger.

The speaker unit 2 includes a vibration plate 21 as illustrated in FIG. 1B an edge 22 for supporting the vibration plate 21, a magnetic circuit (not illustrated) which can drive the vibration plate 21, and a frame (not illustrated) for supporting the edge 22 and the magnetic circuit. The speaker unit 2 is formed into a substantially circular shape entirely as viewed from above. The speaker unit 2 is placed on an upper surface of the enclosure 3, and emits sound to the room space of the vehicle C through the opening O.

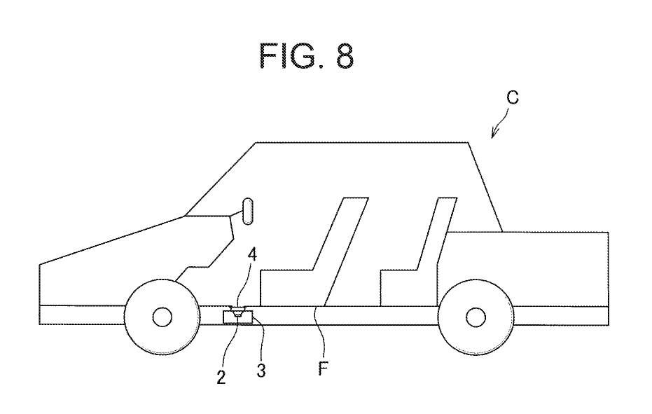

The enclosure 3 is provided below the floor F. A size of the enclosure 3 in the vertical direction may be small, and may extend in the longitudinal direction of the vehicle C as illustrated in FIG. 2, or the enclosure 3 may be formed into a substantially rectangular parallelepiped shape as illustrated in FIG. 8.

The protection member 4 is separated from the floor F and the speaker unit 2, and is formed into a disk-shape (substantially circular plate-shape as viewed from above). An outer peripheral edge of the protection member 4 is located below the opening O, and is located on more outer side than an outer peripheral edge of the opening O. That is, a diameter of the protection member 4 is formed larger than that of the opening O, and the protection member 4 is formed to hide the entire opening O as viewed from below. The outer peripheral edge of the protection member 4 is located above the vibration plate 21, and is located on more outer side than an outer peripheral edge of the vibration plate 21. The diameter of the protection member 4 may be formed larger than the vibration plate 21 and the edge 22 and the protection member 4 may hide the entire speaker unit 2 as viewed from above as illustrated in FIG. 1B, or the diameter of the protection member 4 may be formed smaller than the edge 22 and larger than the vibration plate 21 and the protection member 4 may have a size capable of hiding the vibration plate 21 as viewed from above as illustrated in FIG. 3.

The protection member 4 is supported by a support member 5 from below, thereby mounting the protection member 4 on the enclosure 3. A mesh member M is provided between a lower surface of the floor F, and this configuration prevents foreign matters larger than a mesh of the mesh member M from passing through the mesh member M.

According to the vehicle C provided with the above-described acoustic conversion device 1 for the active noise control, since the opening O is formed at foot of a passenger, there is a possibility that foreign matters such as sand adhering to shoes or water adhering to an umbrella can adversely pass through the opening O. Here, since the protection member 4 hides the entire opening O, all of water and foreign matters which pass through the opening O arrive at the upper surface of the protection member 4. Further, since the protection member 4 hides the entire speaker unit 2, it is possible to protect the vibration plate 21 of the speaker unit 2 from water and foreign matters which drop from the protection member 4.

Since the protection member 4 is separated from the floor F, a sound-introducing path A is formed between the upper surface of the protection member 4 and the lower surface of the floor F around the opening O. Sound emitted from the speaker unit 2 can pass through the sound-introducing path A. Sound which is emitted diagonally upward from the speaker unit 2 is diffracted at the outer peripheral edge of the protection member 4, and moves toward the sound-introducing path A.

The above-described configuration prevents water and foreign matters from adhering to the vibration plate 21, it is possible to prevent lowest resonance frequency of the speaker unit 2 from being varied, emitted sound can be less prone to be deviated from opposite phase of noise which should be suppressed or removed, and it is possible to effectively suppress or remove noise.

Further, since the protection member 4 is separated from the speaker unit 2 and the sound-introducing path A is formed between the protection member 4 and the floor F, it is possible to prevent, as much as possible, sound emitted to the room space from the speaker unit 2 from being shielded by the protection member 4.

Since the protection member 4 is provided lower than the floor F, deterioration of design performance as viewed from the room space can be prevented.

### Example 2

As illustrated in FIG. 3, an acoustic conversion device 1B for an active noise control according to Example 2 includes a speaker unit 2B having a flat surface-shaped vibration plate, and a sound-introducing member 6 provided outside the speaker unit 2B and a protection member 4.

The sound-introducing member 6 includes cylindrical members 61 which opens upward and downward and which surround the speaker unit 2B and the protection member 4 from outside. The sound-introducing member 6 also includes bottom surfaces 62 provided on lower sides of the cylindrical members 61.

Upper ends of the cylindrical members 61 abut against the floor F, and lower ends of the cylindrical members 61 are located lower than an upper surface of an enclosure 3. Sound emitted diagonally upward (outward) from the speaker unit 2B is reflected inward by the cylindrical members 61, and is introduced into a sound-introducing path A.

The bottom surfaces 62 include holes 621 and are fixed to the enclosure 3, and the bottom surfaces 62 are formed such that water and foreign matters can be discharged downward from the holes 621.

A mesh member M having a predetermined load bearing weight (e.g., about body weight of passenger) is provided on an upper surface of the opening O so that a load of the passenger or a loaded article are not applied to the protection member 4.

According to the above-described configuration, sound emitted from the speaker unit 2B is not only diffracted at the outer peripheral edge of the protection member 4, but is also reflected by the cylindrical members 61 and is introduced toward the sound-introducing path A. According to this, emitted sound easily reaches a passenger, and it is possible to effectively suppress or remove noise.

Since the vibration plate of the speaker unit 2B has the flat surface-shape, it is possible to prevent them from staying on the vibration plate, even if water and foreign matters enter the speaker unit 2B.

### Example 3

As illustrated in FIG. 4, an acoustic conversion device 1C for an active noise control according to Example 3 includes a protection member 4C having an upwardly convex upper surface, and a sound-introducing member 6C having cylindrical members 61C. An inner diameter of each of the cylindrical members 61C becomes larger upward.

Protection inclined surfaces 41 are formed on an upper surface of the protection member 4C. An outer peripheral edge of each of the protection inclined surfaces 41 is located lower than its central portion (i.e., protection inclined surface 41 inclines downward from central portion toward outer peripheral edge). Each of the protection member 4C is formed into a conical shape as a whole. An outer peripheral edge of the protection member 4C is located on more outer side than an outer peripheral edge of an upper surface of an enclosure 3, and the protection member 4C hides the entire upper surface of the enclosure 3 as viewed from above.

Since the inner diameter of each of the cylindrical members 61 becomes larger upward, not only sound emitted diagonally upward from the speaker unit 2, but also sound emitted diagonally downward from the speaker unit 2 is prone to be reflected toward a sound-introducing path A.

According to the above-described configuration, since the protection inclined surfaces 41 are formed on the upper surface of the protection member 4C, water and foreign matters which pass through an opening O move downward toward the outer peripheral edges of the protection inclined surfaces 41, and they are less prone to drop inward at the outer peripheral edges. Therefore, it is possible to reliably prevent water and foreign matters from entering the speaker unit 2, and to reliably protect the vibration plate.

Further, since the protection member 4C hides the entire upper surface of the enclosure 3, it is possible to prevent water and foreign matters from arriving at the upper surface of the enclosure 3, and to prevent water and foreign matters from entering the speaker unit 2 through the upper surface of the enclosure 3.

Since sound emitted diagonally downward from the speaker unit 2 is reflected by the cylindrical members 61C toward the sound-introducing path A, emitted sound more easily reaches a passenger, and it is possible to more effectively suppress or remove noise.

### Example 4

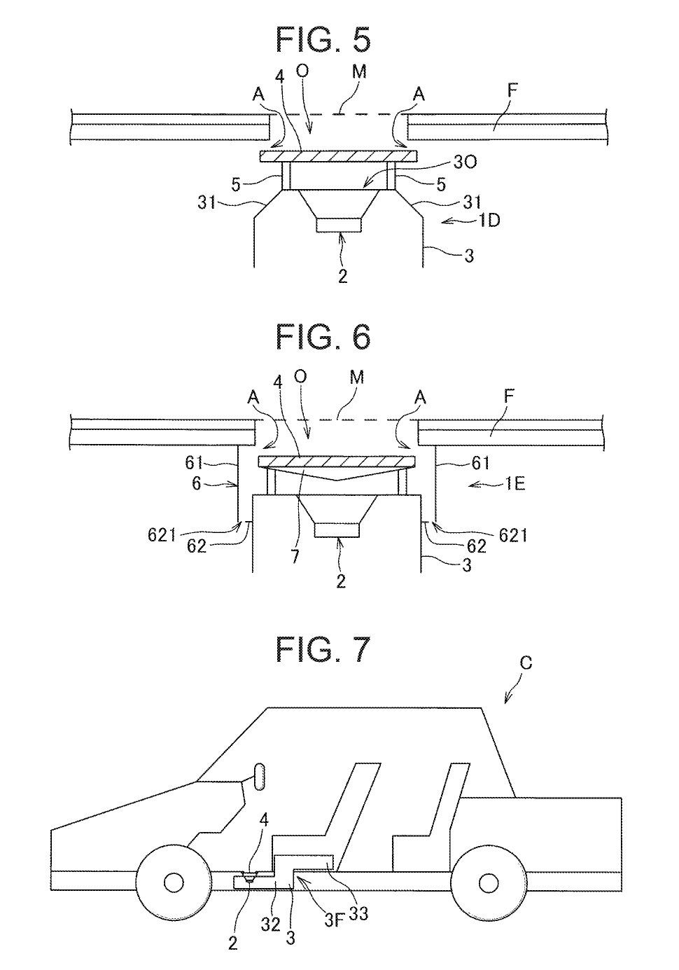

As illustrated in FIG. 5, an acoustic conversion device 1D for an active noise control according to Example 4 includes an enclosure 3D provided at its upper surface with discharging inclined surfaces 31.

A hole 30 is formed in a central portion of the upper surface of the enclosure 3D, and a speaker unit 2 is accommodated in the hole 30. An outer peripheral edge of the enclosure 3D is located lower than that of the hole 30, and the discharging inclined surfaces 31 are formed. That is, the discharging inclined surfaces 31 incline downward from a periphery of the speaker unit 2 toward the outer peripheral edge. Water and foreign matters which drop from a protection member 4 and arrive at the upper surface of the enclosure 3D are discharged downward by the discharging inclined surfaces 31.

According to the above-described configuration, it is possible to prevent water and foreign matters from staying around the speaker unit 2, and to more reliably prevent water and foreign matters from entering the speaker unit 2.

### Example 5

As illustrated in FIG. 6, an acoustic conversion device 1E for an active noise control according to Example 5 includes a sound-introducing member 6 and a diffuser 7 provided on a lower surface of a protection member 4. The diffuser 7 is formed into a downward convex shape. According to this, sound emitted upward from a speaker unit 2 is introduced outward. An outer peripheral edge of the protection member 4 is located on more inner side than an outer peripheral edge of an opening O, and a diameter of the protection member 4 is formed smaller than that of the opening O.

According to the above-described configuration, sound emitted upward from the speaker unit 2 easily moves toward the outer peripheral edge of the protection member 4, the sound is introduced by diffraction, and the sound can easily reach a passenger. Even if sound which is guided outward is not diffracted, the sound is reflected inward by the sound-introducing member 6 and is easily guided by the sound-introducing path A. Further, since the outer peripheral edge of the protection member 4 is located on more inner side than the outer peripheral edge of the opening O, the sound-introducing path A is formed large, and sound emitted from the speaker unit 2 can more easily reach a passenger.

The present invention is not limited to Examples 1 to 5, the invention includes other configurations which can achieve the object of the invention, and the following modifications are also included in the invention.

For example, in Example 1, a vertical side of the enclosure 3 is formed small, the enclosure 3 extends in the longitudinal direction of the vehicle C, and the enclosure 3 is provided along the lower surface of the floor F. Alternatively, as illustrated in FIG. 7, an enclosure 3F may include a first member 32 provided below the floor F and accommodating the speaker unit 2 therein, and a second member 33 provided below a seat S. According to this configuration, since the second member 33 is provided below the seat S, even if an installation space below the floor F is narrow, it is possible to secure a capacity of the enclosure 3F.

Although multiple shapes and sizes of the speaker unit, the enclosure and the protection member are shown in Examples 1 to 5, they may appropriately be combined, and the presence or absence of the sound-introducing member and the diffuser may appropriately be selected.

Although the speaker unit 2, the opening O and the protection member 4 are circular in shape as viewed from above in Example 1, the speaker unit and the opening may have appropriate shapes such as an ellipse. The protection member may have an appropriate shape capable of hiding the opening and the vibration plate. It is more preferable that the protection member has a shape and a size capable of hiding not only the opening and the vibration plate but also the edge.

Although engine noise is selected as noise in Example 1, the configuration may be such that noise such as wind noise and tire friction noise may be suppressed or removed. To suppress or remove such noise, a noise pattern corresponding to a state of a vehicle such a vehicle type, speed and acceleration may previously be stored, sound-collecting means for collected generated noise may be provided, and negating sound corresponding to noise may be emitted.

Although the best configuration and method for carrying out the present invention have been described above, the invention is not limited to them. That is, the invention is illustrated and described concerning the specific embodiment, but a person skilled in the art can variously modify the above-described embodiment in terms of shapes, materials, the numbers and other detailed configurations. Therefore, the descriptions to limit the above-disclosed shapes and materials are described to make it easy to understand the present invention, and they do not limit the invention. Thus, descriptions of names of members from which a portion or all of the limitations such as the shapes and the materials are removed are included in the invention.

### REFERENCE SIGNS LIST

1 acoustic conversion device for an active noise control
2 speaker unit
3 enclosure
4 protection member
6 sound-introducing member
7 diffuser
21 vibration plate
22 edge
31 discharging inclined surface
30 hole
41 protection inclined surface
61 cylindrical member
A sound-introducing path
C vehicle
F floor
opening

1. An acoustic conversion device for an active noise control comprising:
a speaker unit which is provided below an opening formed in a floor of a vehicle and which emits sound to a room space of the vehicle through the opening;
an enclosure in which the speaker unit is accommodated; and
a protection member provided between the opening and the speaker unit,
wherein the speaker unit includes a vibration plate for emitting sound, an edge for supporting the vibration plate, and a frame for supporting the edge, and
wherein an outer peripheral edge of the protection member is located above the vibration plate, and is located on more outer side than an outer peripheral edge of the vibration plate.

2. The acoustic conversion device for the active noise control according to claim 1, wherein the outer peripheral edge of the protection member is located below the opening, and is located on more outer side than an outer peripheral edge of the opening.

3. The acoustic conversion device for the active noise control according to claim 1, wherein an upper surface of the protection member includes a protection inclined surface, and an outer peripheral edge of the protection inclined surface is located below its central portion.

4. The acoustic conversion device for the active noise control according to claim 1, wherein the speaker unit is provided on an upper surface of the enclosure, and
the outer peripheral edge of the protection member is located on more outer side than an outer peripheral edge of the upper surface of the enclosure.

5. The acoustic conversion device for the active noise control according to claim 1, wherein the speaker unit is provided in a hole formed in an upper surface of the enclosure, and
an outer peripheral edge of the upper surface of the enclosure includes a discharge inclined surface located lower than an outer peripheral edge of the hole.

6. The acoustic conversion device for the active noise control according to claim 1, wherein a sound-introducing path through which sound emitted from the speaker unit can pass is formed between a lower surface of the floor and an upper surface of the protection member.

7. The acoustic conversion device for the active noise control according to claim 6, further comprising a sound-introducing member which can guide sound emitted from the speaker unit to the sound-introducing path,
wherein the sound-introducing member includes a cylindrical member which surrounds the speaker unit and the protection member from outside.

8. The acoustic conversion device for the active noise control according to claim 1, wherein a lower surface of the protection member is provided with a diffuser which is downwardly convex.

9. The acoustic conversion device for the active noise control according to claim 1, wherein the vibration plate is formed into a flat surface shape.
